(19) United States
(12) Patent Application Publication
(10) Pub. No.: US 2025/0182287 A1
(43) Pub. Date: Jun. 5, 2025

(54) IMAGE PROCESSING APPARATUS, NON-TRANSITORY COMPUTER READABLE MEDIUM IN WHICH PROGRAM THEREFOR IS RECORDED, AND METHOD

(71) Applicant: NEC Corporation, Minato-ku, Tokyo (JP)

(72) Inventors: Tatsuya FUJIMOTO, Tokyo (JP); Junichi Abe, Tokyo (JP); Akira Tsuji, Tokyo (JP); Hidemi Noguchi, Tokyo (JP)

(73) Assignee: NEC Corporation, Minato-ku, Tokyo (JP)

(21) Appl. No.: 18/844,207

(22) PCT Filed: Apr. 6, 2022
(86) PCT No.: PCT/JP2022/017174

§ 371 Date: Sep. 5, 2024

(51) Int. Cl. G06T 7/11; G06T 7/174; G06V 20/64

(52) U.S. Cl. CPC G06T 7/11; G06T 7/174; G06V 20/64

(57) ABSTRACT

An image processing apparatus according to an example embodiment includes: a two-dimensional data acquisition unit that acquires an image that is two-dimensional data; a three-dimensional data acquisition unit that acquires three-dimensional data for at least a partial region of a range captured as the image; an extraction target region setting unit that outputs two-dimensional coordinates of a region including point cloud data in which distance information of the three-dimensional data is within a preset recognition section as extraction target region coordinates; and an object image extraction unit that extracts an image of the region corresponding to the extraction target region coordinates from the image as an object image.

### TECHNICAL FIELD

The present invention relates to an image processing apparatus, a non-transitory computer readable medium in which a program therefor is recorded, and a method, and more particularly, to an image processing apparatus that cuts out an object image including a predetermined object from a captured image, and a program and a method therefor.

### BACKGROUND ART

In recent years, there has been a demand for a technique for recognizing a specific object reflected in an image acquired by a camera in many fields. Thus, Patent Literature 1 discloses an example of recognition of an object in an image.

An image analysis apparatus described in Patent Literature 1 includes a distance information analysis unit that detects object information including a position and a size of an object from measurement data acquired from LiDAR; an image analysis unit that detects object information from image data acquired from a camera; a capturing condition acquisition unit that acquires capturing conditions in first and second capturing regions of the LiDAR and the camera; and an information integration unit that performs integration processing of integrating a detection result of the distance information analysis unit and a detection result of the image analysis unit in a common region in which the first and second capturing regions overlap on the basis of the acquired capturing conditions, and generates new object information.

### CITATION LIST

### Patent Literature

Patent Literature 1: Japanese Unexamined Patent Application Publication No. 2022-17619

### SUMMARY OF INVENTION

### Technical Problem

However, there is a problem that it is difficult to detect a far object on the basis of an image that is two-dimensional data since there is an overlap between an object in front and the far object in a case where the far object and the near object are reflected in the image.

### Solution to Problem

An image processing apparatus according to an example embodiment includes: a two-dimensional data acquisition unit that acquires an image that is two-dimensional data; a three-dimensional data acquisition unit that acquires three-dimensional data for at least a partial region of a range captured as the image; an extraction target region setting unit that outputs two-dimensional coordinates of a region including point cloud data in which distance information of the three-dimensional data is within a preset recognition section as extraction target region coordinates; and an object image extraction unit that extracts an image of the region corresponding to the extraction target region coordinates from the image as an object image.

A non-transitory computer readable medium in which an image processing program according to an example embodiment is recorded causes an arithmetic unit to execute: two-dimensional data acquisition processing of acquiring an image that is two-dimensional data acquired by a two-dimensional data acquisition unit; three-dimensional data acquisition processing of acquiring three-dimensional data output by a three-dimensional data acquisition unit for at least a partial region of a range captured as the image; extraction target region setting processing of outputting two-dimensional coordinates of a region including point cloud data in which distance information of the three-dimensional data is within a preset recognition section as extraction target region coordinates; and object image extraction processing of extracting an image of the region corresponding to the extraction target region coordinates from the image as an object image.

An image processing method according to an example embodiment causes an arithmetic unit to execute: two-dimensional data acquisition processing of acquiring an image that is two-dimensional data acquired by a two-dimensional data acquisition unit; three-dimensional data acquisition processing of acquiring three-dimensional data output by a three-dimensional data acquisition unit for at least a partial region of a range captured as the image; extraction target region setting processing of outputting two-dimensional coordinates of a region including point cloud data in which distance information of the three-dimensional data is within a preset recognition section as extraction target region coordinates; and object image extraction processing of extracting an image of the region corresponding to the extraction target region coordinates from the image as an object image.

### Advantageous Effects of Invention

With the image processing apparatus, the non-temporary recording medium in which the program therefor is recorded, and the method according to the example embodiments, it is possible to detect a distant object on the basis of an image that is two-dimensional data.

### BRIEF DESCRIPTION OF DRAWINGS

FIG. 1 is a view for describing an object detected by an image processing apparatus according to a first example embodiment.

FIG. 2 is a block diagram of the image processing apparatus according to the first example embodiment.

FIG. 3 is a hardware configuration diagram of the image processing apparatus according to the first example embodiment.

FIG. 4 is a flowchart for describing an operation of the image processing apparatus according to the first example embodiment.

FIG. 5 is a block diagram of an image processing apparatus according to a second example embodiment.

FIG. 6 is a flowchart for describing an operation of the image processing apparatus according to the second example embodiment.

FIG. 7 is a block diagram of the image processing apparatus according to the second example embodiment.

FIG. 8 is a flowchart for describing the operation of the image processing apparatus according to the second example embodiment.

### EXAMPLE EMBODIMENT

To clarify description, in the following description and drawings, omission and simplification are made as appropriate. Further, elements that are illustrated in the drawings as functional blocks for performing various kinds of processing may be configured by a central processing unit (CPU), a memory, or another circuit as hardware or may be implemented by a program loaded to a memory or the like as software. It would be thus obvious to those skilled in the art that those functional blocks may be implemented in various forms such as hardware only, software only or a combination of the both, and not limited to any of them. Note that, in each drawing, the same elements are denoted by the same reference signs, and redundant description is omitted as necessary.

Further, the above-described program can be stored and provided to a computer using any type of non-transitory computer readable media. Non-transitory computer readable media include various types of tangible storage media. Examples of non-transitory computer readable medium include a magnetic recording medium (for example, a flexible disk, a magnetic tape, or a hard disk drive), a magneto-optical recording medium (for example, a magneto-optical disc), a CD-read only memory (ROM) CD-R, a CD-R/W, and a semiconductor memory (for example, a mask ROM, a programmable ROM (PROM), an erasable PROM (EPROM), a flash ROM, and a random access memory (RAM)). Further, the program may also be provided to a computer using various types of transitory computer readable media. Examples of the transitory computer readable media include electric signals, optical signals, and electromagnetic waves. The transitory computer readable media can supply the program to the computer via a wired communication path such as an electric wire and an optical fiber or a wireless communication path.

### First Example Embodiment

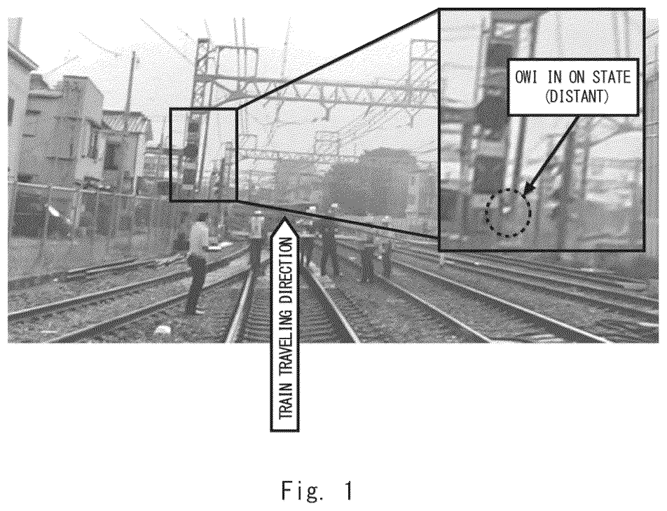

First, an image in which object detection accuracy is enhanced by using an image processing apparatus described in an example embodiment will be described. Thus, FIG. 1 is a view illustrating an object detected by an image processing apparatus according to a first example embodiment. An example illustrated in FIG. 1 is an image obtained by capturing a scene seen in a traveling direction of a train. In the operation of a train, an obstruction warning indicator (OWI in FIG. 1) that can be visually recognized from 800 m or more ahead of a driver of a vehicle is used. This obstruction warning indicator is provided at a point where caution is required against a falling rock, an avalanche, a strong wind, a railroad crossing, and the like. Such an obstruction warning indicator is visually confirmed by the driver, but is normally turned off without abnormality, and it is difficult to immediately react due to the particularity of emitting a stop signal at an unexpected timing. Therefore, there is a request to issue a warning to the driver by detecting a signal installed far away, an obstacle, and the like, but as illustrated in FIG. 1, the obstruction warning indicator to be detected is more hidden than a support for hanging an overhead line, and thus is hardly detected from one image.

Thus, the image processing apparatus to be described below generates an object image obtained by cutting out only a capturing range at a distance of a preset recognition section by utilizing three-dimensional data for measuring distance information of light detection and ranging (LiDAR) or the like. When such an object image is used, it is possible to exclude a thing that hinders recognition of a thing to be detected in a far-near direction, so that the image processing apparatus to be described below can improve the object recognition accuracy. The object recognition using such an object image is processing required not only in a railway but also in all movable moving bodies such as automobiles and drones.

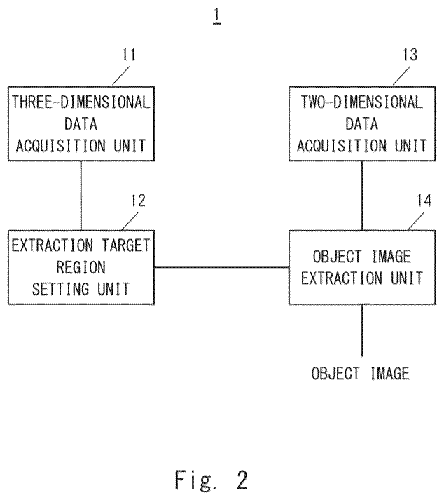

FIG. 2 is a block diagram of an image processing apparatus 1 according to the first example embodiment. As illustrated in FIG. 1, the image processing apparatus 1 according to the first example embodiment includes a three-dimensional data acquisition unit 11, an extraction target region setting unit 12, a two-dimensional data acquisition unit 13, and an object image extraction unit 14.

The three-dimensional data acquisition unit 11 acquires three-dimensional data for at least a partial region of a range captured as an image acquired by the two-dimensional data acquisition unit 13. The three-dimensional data acquisition unit 11 outputs, for example, point cloud data that is a set of measurement points whose values change according to the magnitude of a distance of LiDAR or the like.

The extraction target region setting unit 12 outputs two-dimensional coordinates of a region including point cloud data in which distance information of the three-dimensional data is within a preset recognition section as extraction target region coordinates. That is, the extraction target region coordinates are two-dimensional coordinates of a portion where an object exists in a range of the recognition section.

The two-dimensional data acquisition unit 13 acquires an image that is two-dimensional data. Here, the two-dimensional data acquisition unit 13 is a device that outputs a capturing range of, for example, an optical camera, an infrared camera, or the like as two-dimensional image information.

The object image extraction unit 14 extracts an image of a region corresponding to the extraction target region coordinates from the image as an object image. Here, in the image processing apparatus 1, it is assumed that two-dimensional coordinates of a capturing range of the extraction target region setting unit 12 and two-dimensional coordinates of the point cloud data of the three-dimensional data of the three-dimensional data acquisition unit 11 are calibrated in advance to match each other. Further, since the number of pixels of the point cloud data is smaller than the number of pixels of the image output by the two-dimensional data acquisition unit 13, it is preferable that the object image extraction unit 14 extracts, as the object image, an image of a range slightly wider than the range designated by the extraction target region coordinates in consideration of such a difference in the number of pixels when extracting the object image from the image.

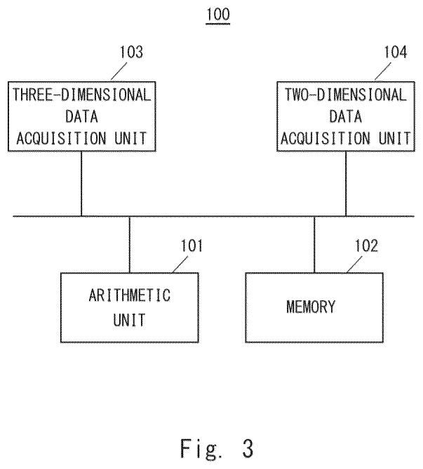

The image processing apparatus 1 according to the first example embodiment can also be configured as dedicated hardware, and can also be implemented by executing an image processing program on a computer. Thus, FIG. 3 illustrates a hardware configuration diagram of the image processing apparatus according to the first example embodiment. FIG. 3 illustrates a computer 100 as a hardware configuration of the image processing apparatus 1.

The computer 100 includes an arithmetic unit 101, a memory 102, a three-dimensional data acquisition unit 103, and an object image extraction unit 14. Then, in the computer 100, the arithmetic unit 101, the memory 102, the three-dimensional data acquisition unit 103, and a two-dimensional data acquisition unit 104 are configured to be able to communicate with each other via a bus.

In FIG. 3, the three-dimensional data acquisition unit 103 and the two-dimensional data acquisition unit 104 are physical hardware such as sensors, and image data and three-dimensional data are accumulated in the memory 102 via the bus. The arithmetic unit 101 executes the image processing program and outputs a generated object image to the memory 102. Further, the memory 102 is a storage device that accumulates data handled by the computer, such as a volatile memory such as a DRAM or a nonvolatile memory such as a flash memory.

The image processing program causes the arithmetic unit 101 to perform two-dimensional data acquisition processing, three-dimensional data acquisition processing, extraction target region setting processing, object image extraction processing, and the like. The two-dimensional data acquisition processing is processing performed by the two-dimensional data acquisition unit 13 to store an image, which is two-dimensional data acquired by the two-dimensional data acquisition unit 104, in the memory 102. The three-dimensional data acquisition processing is processing performed by the three-dimensional data acquisition unit 11 to store three-dimensional data, output from the three-dimensional data acquisition unit 103 for at least a partial region of a range captured as the image acquired by the two-dimensional data acquisition unit 104, in the memory 102. The extraction target region setting processing is processing performed by the extraction target region setting unit 12 to output two-dimensional coordinates of a region including point cloud data in which distance information of the three-dimensional data is within a preset recognition section as extraction target region coordinates. The object image extraction processing is processing performed by the object image extraction unit 14 to extract an image of the region corresponding to the extraction target region coordinates from the image as an object image. Note that the arithmetic unit 101 may directly acquire data from the three-dimensional data acquisition unit 103 and the two-dimensional data acquisition unit 104 without passing through the memory 102.

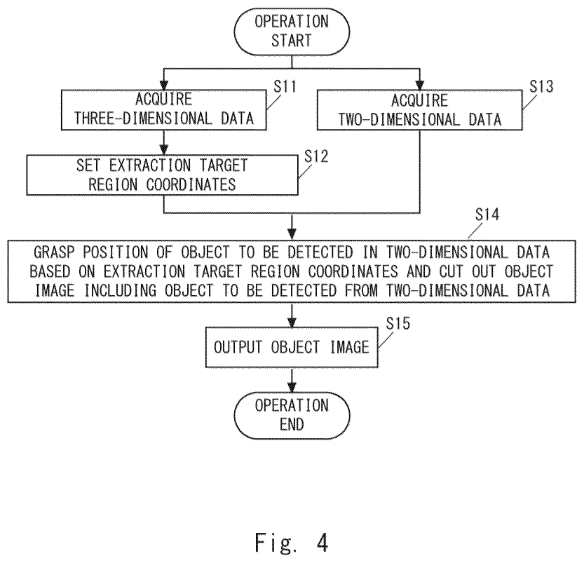

Here, an operation of the image processing apparatus 1 according to the first example embodiment will be described. Thus, FIG. 4 is a flowchart illustrating the operation of the image processing apparatus according to the first example embodiment.

As illustrated in FIG. 4, when starting the operation, the image processing apparatus 1 acquires three-dimensional data by the three-dimensional data acquisition unit 11 (step S11). Then, the image processing apparatus 1 uses the extraction target region setting unit 12 to set two-dimensional coordinates of point cloud data obtained from an object at a distance of a recognition section, which is a predetermined distance from a capturing position, as extraction target region coordinates (step S12). Further, the image processing apparatus 1 acquires two-dimensional data (for example, an image) by the two-dimensional data acquisition unit 13 in parallel with the processing of steps S11 and S12 (step S13). Thereafter, the image processing apparatus 1 grasps a position of an object to be detected in the two-dimensional data on the basis of the extraction target region coordinates, and cuts out an object image including the object to be detected from the two-dimensional data (step S14). Then, the object image extraction unit 14 outputs the object image, whereby the operation of outputting one object image is completed (step $15). The image processing apparatus 1 repeatedly executes the operation of steps S11 to S15 at a predetermined cycle.

As described above, the image processing apparatus 1 according to the first example embodiment outputs the object image including only the image in which the object in the recognition section is reflected. As a result, the amount of information processing when the object to be detected is recognized from the object image output by the image processing apparatus 1 is reduced. Further, it is possible to improve the recognition accuracy by performing the object recognition using the object image including only the object at the distance at which a detection object is assumed to be present from the distance information.

### Second Example Embodiment

In a second example embodiment, an image processing apparatus 2, which is another form of the image processing apparatus 1 according to the first example embodiment, will be described. Note that the same constituent elements as constituent elements described in the first example embodiment are denoted by the same reference signs as those in the first example embodiment, and the description thereof will be omitted.

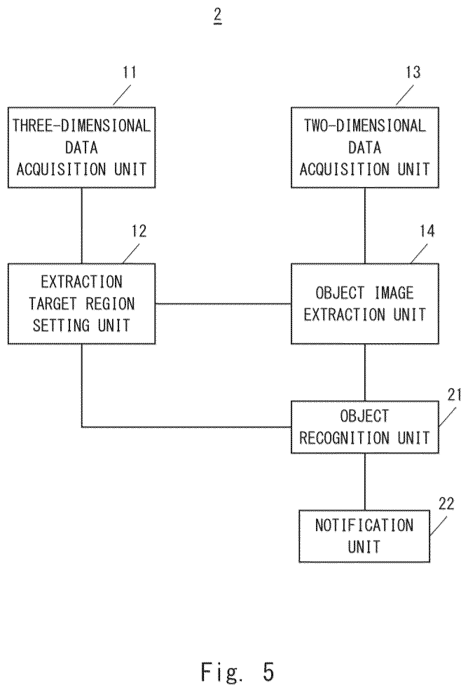

FIG. 5 is a block diagram of the image processing apparatus 2 according to the second example embodiment. As illustrated in FIG. 5, the image processing apparatus 2 according to the second example embodiment is obtained by adding an object recognition unit 21 and a notification unit 22 to the image processing apparatus 1 according to the first example embodiment. The object recognition unit 21 recognizes an object included in an object image. Further, the object recognition unit 21 may recognize an object in consideration of extraction target region coordinates when recognizing the object. For example, the object recognition unit 21 can recognize an object to be recognized by comparing the object with a detection target candidate registered in advance, or can perform recognition using artificial intelligence. The notification unit 22 notifies information regarding the object recognized by the object recognition unit 21.

For example, the object recognition unit 21 recognizes, as the object, at least one of a signal (for example, an obstruction warning indicator) disposed in a capturing range of a two-dimensional data acquisition unit, a rock, a fallen tree, or a person existing in a restricted area set for the capturing range of the two-dimensional data acquisition unit. Further, when the obstruction warning indicator is to be recognized, a light emission pattern is also recognized from an image. The notification unit 22 notifies a person or a device that receives a notification, such as a driver, of a recognition result on the basis of the object or the light emission pattern recognized by the object recognition unit 21. Here, various devices such as a railway operation control system and a vehicle brake can be considered as the device that receives the notification.

Note that operations of the object recognition unit 21 and the notification unit 22 can also be implemented by the image processing program executed by the arithmetic unit 101 illustrated in FIG. 3.

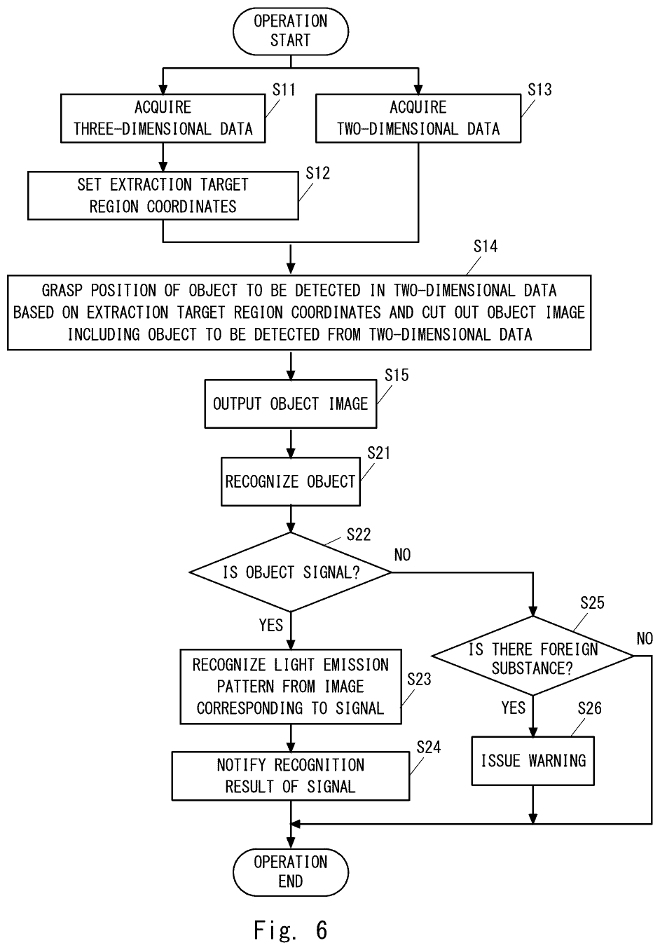

Next, an operation of the image processing apparatus 2 according to the second example embodiment will be described. FIG. 6 is a flowchart for describing the operation of the image processing apparatus 2 according to the second example embodiment. As illustrated in FIG. 6, in the operation of the image processing apparatus 2 according to the second example embodiment, processing of steps S21 to S26 is performed using the object image output in step S15 of the operation of the image processing apparatus 1 according to the first example embodiment illustrated in FIG. 4.

In step S21, the object recognition unit 21 recognizes an object using the object image output in step S15. Then, if the recognized object is a signal (YES branch in step S22), the object recognition unit 21 recognizes a light emission pattern from an image corresponding to the signal, and notifies a driver of a recognition result of the light emission pattern using the notification unit 22 (steps S22 to S24). On the other hand, if the recognized object is other than the signal (NO branch in step S22), the object recognition unit 21 issues a warning to the driver when the object corresponds to a foreign substance for which a warning needs to be issued (YES branch in step S25, step S26), and ends the operation without issuing a warning when the object is a thing that does not require any warning (NO branch in step S25).

As described above, with image processing apparatus 2 according to the second example embodiment, it is possible to issue a specific recognition result or the warning to the driver using the object image output by the object image extraction unit 14. Further, in the image processing apparatus 2 according to the second example embodiment, recognition processing by the object recognition unit 21 can be performed with a small amount of calculation using the object image output by the object image extraction unit 14.

### Third Example Embodiment

In a third example embodiment, an image processing apparatus 3, which is another form of the image processing apparatus 2 according to the second example embodiment, will be described. Note that the same constituent elements as constituent elements described in the first and second example embodiments are denoted by the same reference signs as those in the first and second example embodiments, and the description thereof will be omitted.

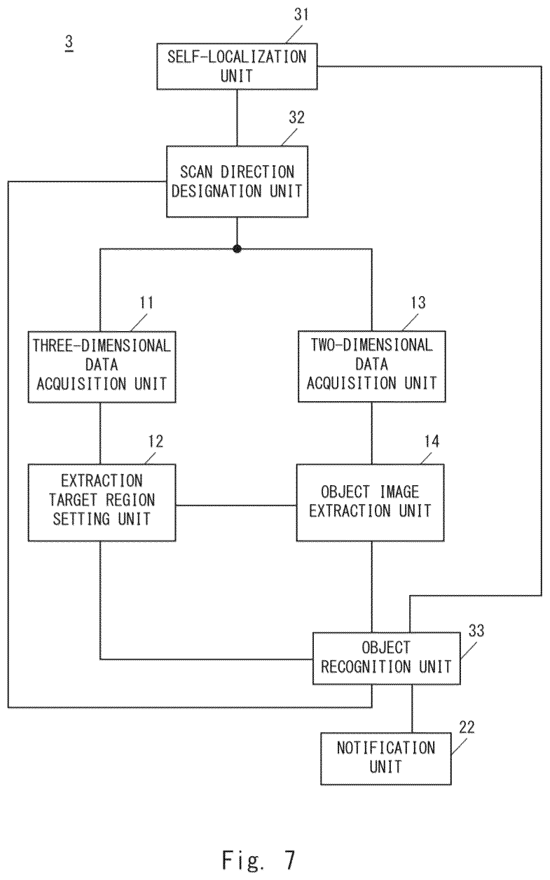

FIG. 7 is a block diagram of the image processing apparatus 3 according to the third example embodiment. As illustrated in FIG. 7, the image processing apparatus 3 according to the third example embodiment is obtained by adding a self-localization unit 31 and a scan direction designation unit 32 to the image processing apparatus 2 according to the second example embodiment, and replacing the object recognition unit 21 with an object recognition unit 33.

The self-localization unit 31 estimates a current position of the own apparatus and outputs self-localization information. The self-localization unit 31 outputs, for example, position information acquired using an apparatus such as a GPS and a current position of a vehicle on which the image processing apparatus 3 is mounted as the self-localization information.

The scan direction designation unit 32 designates a direction in which two-dimensional data is to be acquired and a direction in which three-dimensional data is to be acquired. More specifically, the scan direction designation unit 32 grasps a current geographical position of the own apparatus from the self-localization information, and gives an orientation control instruction to the three-dimensional data acquisition unit 11 and the two-dimensional data acquisition unit 13 such that the three-dimensional data acquisition unit 11 and the two-dimensional data acquisition unit 13 are oriented in a capturing direction Therefore, the three-dimensional data associated with the grasped position. acquisition unit 11 and the two-dimensional data acquisition unit 13 include a mechanism capable of changing the orientation. Further, in a case where a direction of an object to be detected can be estimated by a recognition result of the object recognition unit 33, the scan direction designation unit 32 designates the direction in which two-dimensional data is to be acquired and the direction in which three-dimensional data is to be acquired using the result thereof. That is, in the third example embodiment, the recognition result of the object recognition unit 33 is fed back to the scan direction designation unit 32, thereby enhancing the efficiency of scanning of the object to be detected.

The object recognition unit 33 switches a candidate list in which an object to be recognized is described according to the self-localization information. The image processing apparatus 3 is mounted on a moving body, and it can be considered that a type of object that needs to be recognized varies depending on a geographical position of the moving body. Thus, the object recognition unit 33 can shorten a processing time by switching the candidate list in which things to be recognized are listed on the basis of the self-localization information.

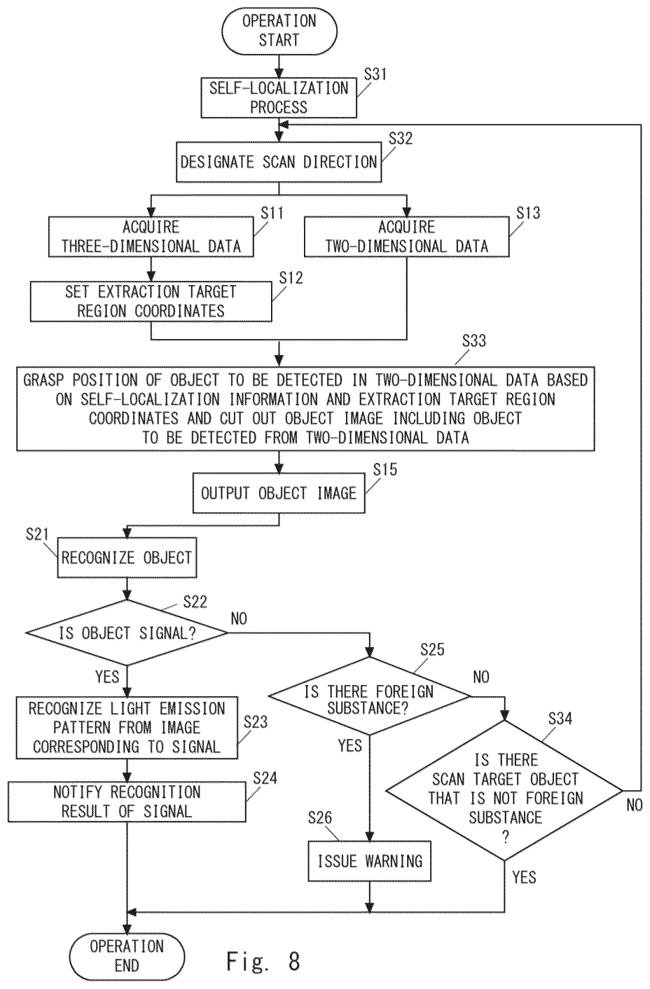

Here, FIG. 8 is a flowchart for describing an operation of the image processing apparatus 3 according to the third example embodiment. As illustrated in FIG. 8, the image processing apparatus 3 according to the third example embodiment performs processing of steps S31 and S32 before steps S11 and S13 of the image processing apparatus 2 according to the second example embodiment illustrated in FIG. 6, and performs processing of step S33 instead of step S14. Further, processing of step S34 is performed after the processing of step S25.

When starting the operation, the image processing apparatus 3 according to the third example embodiment first performs self-localization processing of outputting self-localization information by the self-localization unit 31 (step S31). Then, in the image processing apparatus 3, the scan direction designation unit 32 designates scan directions of the three-dimensional data acquisition unit 11 and the two-dimensional data acquisition unit 13 using the self-localization information (step S32). Thereafter, the image processing apparatus 3 performs the processing of step S11 and subsequent steps.

Further, in the image processing apparatus 3 according to the third example embodiment, the processing of step S14 is replaced with step S33. In step S33, the object recognition unit 33 grasps a position of an object to be detected in two-dimensional data on the basis of the self-localization information and extraction target region coordinates, and cuts out an object image including the object to be detected from the two-dimensional data.

Furthermore, in the image processing apparatus 3 according to the third example embodiment, after it is determined in step S25 that there is no foreign substance, it is further determined whether or not there is an object which is not a foreign substance but is a scan target candidate (step S34). If it is determined in step S34 that there is an object to be scanned, a position thereof in the image is fed back to the scan direction designation unit 32 (NO branch in step S24). On the other hand, if it is determined in step S34 that there is no object to be scanned, the processing ends.

As described above, in the image processing apparatus 3 according to the third example embodiment, by changing the scan directions of the three-dimensional data acquisition unit 11 and the two-dimensional data acquisition unit 13 according to the position, the detection accuracy of the object to be detected can be enhanced even if capturing angles of view of the three-dimensional data acquisition unit 11 and the extraction target region setting unit 12 are narrow. Further, in the image processing apparatus 3 according to the third example embodiment, the probability that the object to be detected is hidden by another object can be reduced by changing the scan directions of the three-dimensional data acquisition unit 11 and the two-dimensional data acquisition unit 13.

Note that the present invention is not limited to the above example embodiments, and can be appropriately changed without departing from the gist.

### REFERENCE SIGNS LIST

1 to 3 IMAGE PROCESSING APPARATUS
11 THREE-DIMENSIONAL DATA ACQUISITION UNIT
12 EXTRACTION TARGET REGION SETTING UNIT
13 TWO-DIMENSIONAL DATA ACQUISITION UNIT
14 OBJECT IMAGE EXTRACTION UNIT
21 OBJECT RECOGNITION UNIT
22 NOTIFICATION UNIT
31 SELF-LOCALIZATION UNIT
32 SCAN DIRECTION DESIGNATION UNIT
33 OBJECT RECOGNITION UNIT
100 COMPUTER
101 ARITHMETIC UNIT
102 MEMORY
103 THREE-DIMENSIONAL DATA ACQUISITION UNIT
104 TWO-DIMENSIONAL DATA ACQUISITION UNIT

1. An image processing apparatus comprising:
a two-dimensional data acquisition unit that acquires an image that is two-dimensional data:
a three-dimensional data acquisition unit that acquires three-dimensional data for at least a partial region of a range captured as the image:
an extraction target region setting unit that outputs two-dimensional coordinates of a region including point cloud data in which distance information of the three-dimensional data is within a preset recognition section as extraction target region coordinates: and
an object image extraction unit that extracts an image of the region corresponding to the extraction target region coordinates from the image as an object image.

2. The image processing apparatus according to claim 1, further comprising an object recognition unit that recognizes an object included in the object image.

3. The image processing apparatus according to claim 2, wherein the object recognition unit recognizes the object in consideration of the extraction target region coordinates.

4. The image processing apparatus according to claim 2, further comprising a notification unit that notifies information regarding the object recognized by the object recognition unit.

5. The image processing apparatus according to claim 2, further comprising a self-localization unit that estimates a current position of the own apparatus and outputs self-localization information,
wherein the object recognition unit switches a candidate list in which the object to be recognized is described according to the self-localization information.

6. The image processing apparatus according to claim 2, wherein the object includes at least one of a signal disposed in a capturing range of the two-dimensional data acquisition unit, and a rock, a fallen tree, and a person existing in a restricted area set with respect to the capturing range of the two-dimensional data acquisition unit.

7. The image processing apparatus according to claim 1, further comprising:
a self-localization unit that estimates a current position of the own apparatus and outputs self-localization information: and
a scan direction designation unit that designates a direction in which the two-dimensional data is to be acquired and a direction in which the three-dimensional data is to be acquired,
wherein the two-dimensional data acquisition unit and the three-dimensional data acquisition unit acquire data in the directions designated by the scan direction designation unit.

8. The image processing apparatus according to claim 1, wherein the three-dimensional data acquisition unit outputs point cloud data that is a set of measurement points whose values change according to a magnitude of a distance.

9. A non-transitory computer readable medium recording an image processing program for causing an arithmetic unit to execute:
two-dimensional data acquisition processing of acquiring an image that is two-dimensional data acquired by a two-dimensional data acquisition unit:
three-dimensional data acquisition processing of acquiring three-dimensional data output by a three-dimensional data acquisition unit for at least a partial region of a range captured as the image:
extraction target region setting processing of outputting two-dimensional coordinates of a region including point cloud data in which distance information of the three-dimensional data is within a preset recognition section as extraction target region coordinates: and
object image extraction processing of extracting an image of the region corresponding to the extraction target region coordinates from the image as an object image.

10. An image processing method for causing an arithmetic unit to execute:
two-dimensional data acquisition processing of acquiring an image that is two-dimensional data acquired by a two-dimensional data acquisition unit;
three-dimensional data acquisition processing of acquiring three-dimensional data output by a three-dimensional data acquisition unit for at least a partial region of a range captured as the image;
extraction target region setting processing of outputting two-dimensional coordinates of a region including point cloud data in which distance information of the three-dimensional data is within a preset recognition section as extraction target region coordinates; and
object image extraction processing of extracting an image of the region corresponding to the extraction target region coordinates from the image as an object image.
